(19) United States
(12) Patent Application Publication
(10) Pub. No.: US 2007/0172614 A1
(43) Pub. Date: Jul. 26, 2007

(54) Heat shrinkable multilayer film and tube with improved adhesion after orientation

(76) Inventor: I-Hwa Lee, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/644,976

(22) Filed: Dec. 22, 2006

Related U.S. Application Data
(60) Provisional application No. 60/755,460, filed on Dec. 30, 2005.

(51) Int. Cl. B32B 27/36; B32B 27/00; B32B 27/34; B32B 27/30; B32B 27/32; B32B 1/02

(52) U.S. Cl. 428/35.7; 428/474.4; 428/500; 428/522; 428/523; 428/480; 428/412

(57) ABSTRACT

Multilayer laminated shrink films that have good interlayer adhesion comprise at least three layers, a first layer comprising a polymer selected from the group consisting of polyamides, ethylene vinyl alcohol copolymers and mixtures thereof, a second adhesive layer consisting essentially of a blend of a functionalized polymer component, an ethylene copolymer component and a tackifier and a third layer comprising a polymer selected from the group consisting of polyethylene homopolymers, ethylene copolymers, polypropylene homopolymers, propylene copolymers, polyesters, polyamides, polyvinyl chloride, polycarbonates, and mixtures thereof The adhesive layer is positioned between and contacts the first and third layers.

### CROSS REFERENCE TO RELATED APPLICATION

This application claims the benefit of U.S. Provisional Application No. 60/755,460, filed Dec. 30, 2005.

### FIELD OF THE INVENTION

This invention relates to heat-shrinkable laminated films that are particularly useful in packaging applications and that exhibit good interlayer adhesion after orientation.

### BACKGROUND OF THE INVENTION

Orientation of multilayer films is generally carried out on a commercial scale using tenterframe or double bubble tubular processes conducted at temperatures below the melting point of at least one of the polymers present in the multilayer film. At such temperatures orientation-induced stresses result that adversely affect interlayer adhesion in many laminated film products. Often substantial decreases in interlayer adhesive strength are exhibited by the oriented multilayer films when compared to multilayer films of similar gauge made by processes that impart a lower degree of orientation, for example multilayer films produced by a cast film or single bubble blown film process.

In some oriented film laminate structures, particularly those where a high degree of shrinkage is not required, the loss in adhesive strength may be alleviated by use of a thermal annealing or heat setting process step following film orientation. This reduces residual stresses in the film. However, for shrink films that require a high degree of shrink, such as shrink bags, the use of such a step is undesirable because it causes a reduction in the degree of shrinkage.

One solution to this problem that has been investigated in the prior art is the use of interlayer adhesives as tie layers. Many adhesive blends of polyolefin polymers have been designed that provide high adhesive performance in cast and blown film multilayer barrier films. Adhesive blends have also been used in oriented shrink films.

For example, U.S. patent application Ser. No.11/257542 discloses an adhesive composition suitable for use in a multilayer laminate shrink film wherein the shrink film comprises at least two structural layers and at least one adhesive layer, and wherein (a) the shrink film is oriented at an orientation temperature (Tₒ), (b) the adhesive composition comprises at least 60% by weight, based on the total adhesive composition, of at least one polymeric adhesive component having a melting point at or below Tₒ, and (c) the melt temperature of the adhesive composition is less than the melt temperature of the major component of the lowest melting structural layer.

U.S. Pat. No. 6,551,674 B2 discloses an oriented multilayer film having an outer layer of a propylene copolymer. The adhesive that bonds the outer layer to the inner sealing layer is selected from the group consisting of ethylene alkyl acrylate copolymers; propylene alpha-olefin copolymers with propylene contents lower than the propylene copolymer of the outer layer; and an ethylene vinyl acetate polymer with at least 15 weight % vinyl acetate.

U.S. Pat. No. 6,221,470 B1 discloses a thermoplastic multilayer packaging film that can be heat shrinkable wherein a core layer or layers includes ethylene vinyl alcohol and polyamide. The use of modified homogeneous ethylene alpha-olefin copolymers with a density of 0.900 to 0.908 g/cc as adhesive layers to improve interlayer adhesion is disclosed.

U.S. Pat. No. 6,210,765 B1 describes a multilayer laminated film containing a polyamide resin or an ethylene vinyl alcohol resin where the adhesive is a polyethylene composition consisting essentially of an unsaturated carboxylic acid or anhydride modified ethylene alpha-olefin copolymer resin or elastomer, an unmodified ethylene alpha-olefin copolymer resin or elastomer, and a tackifier. Such a film may be monoaxially or biaxially oriented.

U.S. Pat. No. 5,759,648 discloses a biaxially oriented film of at least five layers where the adhesive layers comprise at least 10 weight % of an ethylene alpha-olefin copolymer having a melt index below 1 g/10 minutes and a density between 0.900 and 0.915 g/cc; at least 10 weight % of an ethylene copolymer with from 4 to 18 weight % of vinyl ester or alkyl acrylate; at least 10 weight % of an anhydride-modified ethylene vinyl ester or alkyl acrylate copolymer; and 0 to 30 weight % of an ethylene alpha-olefin of density below 0.900 g/cc and a melt point below 85° C. One adhesive layer is disclosed as being an unusually thick adhesive layer that contributes to the ease of orientation and facilitates high shrink.

U.S. Pat. No. 5,382,470 discloses a biaxially stretched heat shrinkable film comprising a blend of ethylene vinyl alcohol and nylon 6,6 as a core layer. Intermediate adhesive layers comprise a blend of 35 to 80 weight % very low density polyethylene and 20 to 40 weight % of either an anhydride-modified polyethylene adhesive having a melt index below 1.7 g/10 minutes at 190° C. or an anhydride-modified ethylene vinyl acetate adhesive of melt index below 0.5 g/10 minutes at 190° C., and 0 to 40 weight % of ethylene vinyl acetate having a melt index less than 1 g/10 minutes at 190° C., and 7 to 15 weight % vinyl acetate.

U.S. Pat. No. 4,857,399 discloses a four layer shrink film having a barrier layer that may include ethylene vinyl alcohol and polyamide and an adhesive layer comprising a blend of between 20 and 60 weight % of an anhydride modified ethylene copolymer adhesive having a Vicat softening point of at least about 90° C. and between 40 and 80 weight % of an ethylene copolymer with from 4 to 15 weight % of vinyl acetate.

U.S. Pat. No. 4,762,748 discloses a pasteurizable or cook-in shrink film with good interlaminar adhesion made using a chemically modified ethylene alkyl acrylate or ethylene vinyl acetate polymer as a component of the adhesive.

U.S. Pat. No. 4,424,243 describes a heat shrinkable laminate film containing a polyvinylidene chloride core, wherein the intermediate layer between the core and the outer layer is a thermoplastic resin having a crystalline melting point of from 70° C. to 100° C. The intermediate layer is from 50 to 80% of the total thickness of the intermediate and outer layers.

U.S. Pat. No. 4,474,634 discloses a laminating process by which various layers of varying degrees of orientation are laminated using a thermoplastic synthetic resin adhesive. Suitable adhesives are disclosed to be those having a lower melting point than the resins forming the oriented layers, for example having melting points 10 to 80° C. lower.

“Bi-Axially Oriented Film”, Research Disclosure Journal, 448065, August 2001 discloses a biaxially oriented heat shrinkable multilayer film of at least three layers where the adhesive composition comprises a blend of 60 to 95 weight % ethylene alkyl (meth)acrylate or vinyl ester, 4 to 40 weight % of an acid grafted metallocene polyethylene and optionally up to 30 weight % polyolefin elastomer.

U.S Pat. No. 5,217,812 discloses an extrudable bonding resin, useful in preparation of polyester laminates, having (a) 65 to 99 weight % of an ethylene copolymer portion consisting essentially of (i) an ethylene copolymer with about 20 to 50 weight % vinyl esters or other esters of unsaturated mono or dicarboxylic acids of 2 to 20 carbon atoms further modified by 0.03 to 10 weight % of carboxylic acid anhydrides; and optionally (ii) an ethylene copolymer with about 20 to 50 weight % vinyl esters or other esters of unsaturated mono or dicarboxylic acids of 2 to 20 carbon atoms; and (b) 1 to 35 weight % of a tackifying resin.

However, there remains a need for multilayer film laminates having improved interlayer adhesion in heat shrink packaging applications where the laminate is subjected to biaxial orientation processes and a high degree of shrink is required.

### SUMMARY OF THE INVENTION

In one aspect the present invention is a multilayer laminated heat shrinkable film comprising
A) a first layer having an outer surface and an inner surface, said first layer comprising a polymer selected from the group consisting of polyamides, ethylene vinyl alcohol copolymers and mixtures thereof;
B) a second layer consisting essentially of
   1) at least one functionalized polymer component selected from the group consisting of a) anhydride-modified polymers, b) copolymers comprising copolymerized units of ethylene and a comonomer selected from the group consisting of C₄-C₈ unsaturated anhydrides, monoesters of C₄-C₈ unsaturated acids having at least two carboxylic acid groups, diesters of C₄-C₈ unsaturated acids having at least two carboxylic acid groups and c) mixtures thereof,
   2) an ethylene copolymer, chemically distinct from said functionalized polymer component, comprising copolymerized units of ethylene and a comonomer selected from the group consisting of vinyl acetate, alkyl acrylates, alkyl methacrylates and mixtures thereof, said alkyl groups having from 1 to 10 carbon atoms; and
   3) a tackifier resin; and
C) a third layer having an outer surface and an inner surface, said third layer comprising a polymer selected from the group consisting of polyethylene homopolymers, ethylene copolymers, polypropylene homopolymers, propylene copolymers, polyesters, polyamides, polyvinyl chloride, polycarbonates, and mixtures thereof
wherein said second layer is positioned between and in contact with the inner surfaces of said first and third layers and, when subjected to a temperature of 95° C., said multilayer shrinkable film shrinks to an extent that it is 85% or less of its original size.

### DETAILED DESCRIPTION OF THE INVENTION

Multilayer film laminates are used in a variety of applications, including packaging applications. Some packaging applications require multilayer films that can be shrunk to a custom fit around the contents of the package. Such films are conventionally known as “shrink films,” “shrink wraps” and/or “shrinkbags”, and are referred to hereinafter as such. The present invention is directed to multilayer laminated shrink films and to structures made from such films.

As used herein, the term “heat-shrinkable film” or “shrink film” means a film that shrinks in size to 85% or less of its original dimensions (that is, the film will shrink in size an amount of 15% or more from its original dimensions so that its area will be 85% or less of its original area) when exposed to a temperature of 95° C. Depending upon the specific application in which they are used, some shrinkable films may be required to accommodate a moderate level of shrinkage, for example 15% shrinkage, from the original film dimensions. Films used in sausage casings, for example, require only a moderate amount of shrinkage. In other applications, shrink films may be required to accommodate greater degrees of shrinkage, for example 50% reduction or more from the original film dimensions. Applications for shrink bags, for example, can require from about 40% to about 50% shrinkage from the original dimensions.

The term “film” as used herein includes films, sheets and plastic web. The film can be a thin film or a thicker film, commonly known as a sheet. The thickness of the “film” will be 0.25 mm or less. “Lay-flat film” refers to a film that has been extruded as a wide, thin-walled, circular tube, usually blown, cooled, then gathered by converging sets of rollers and wound up in flattened form. “Lay-flat width” refers -to half of the circumference of the inflated film tube. A film may also be produced by casting from a flat die onto a chilled roll. Shrink films can be obtained by known methods wherein a film is biaxially oriented, that is, stretched along two axes.

In one embodiment, the present invention is a multilayer laminated heat shrinkable film that can be used in demanding shrink film applications, comprising an adhesive composition that is used as an adhesive layer or “tie” layer. Demanding shrink film applications are those applications that require a film to shrink more than 15% from its original dimensions, i.e. to shrink to less than 85% of its original dimensions. More demanding applications can require that a film shrink to 70% or less of it original dimensions (i.e., the film shrinks to a degree of 30% or more from its original dimensions). Even more demanding shrink film applications may require shrinkage to 60% or less and even 50% or less of the original dimensions of the film (i.e., the film shrinks to a degree of 40% or more in the former case and to a degree of 50% or more in the latter case from its original dimensions).

The adhesive composition as described herein is particularly suitable for use as a tie layer in multilayer laminated shrink films, especially those that require a high degree of shrink. The adhesive composition provides suitable adhesion between the various layers of the laminate film and provides improved adhesion in biaxially oriented films.

The first layer of the multilayer laminated heat shrinkable films of the invention comprises a polymer selected from the group consisting of polyamides, ethylene vinyl alcohol polymers and mixtures thereof.

Polyamides suitable for use are generally prepared by polymerization of lactams or amino acids (e.g. nylon 6 or nylon 11), or by condensation of diamines such as hexamethylene diamine with dibasic acids such as succinic, adipic, or sebacic acid. The polyamides may also include copolymerized units of additional comonomers to form terpolymers or higher order polymers. The polyamide can include nylon 6, nylon 9, nylon 10, nylon 11, nylon 12; nylon 6,6, nylon 6,10, nylon 6,12, nylon 61, nylon 6T, nylon 6.9, nylon 12,12, copolymers thereof and blends of amorphous and semicrystalline polyamides. As used herein the term polyamide also includes polyamide nano-composites such as those available commercially under the tradename Aegis® polyamides from Honeywell or Imperm® polyamide (nylon MXD6) from Mitsubishi Gas Chemicals/Nanocor.

Preferred polyamides include polyepsiloncaprolactam (nylon 6); polyhexamethylene adipamide (nylon 6,6); nylon 11; nylon 12, nylon 12,12 and copolymers and terpolymers such as nylon 6/6,6; nylon 6,10; nylon 6,12; nylon 6,6/12; nylon 6/6,6/6,10 and nylon 6/6T. More preferred polyamides are polyepsiloncaprolactam (nylon 6), polyhexamethylene adipamide (nylon 6,6), and most preferred is nylon 6. Although these polyamides are preferred polyamides, other polyamides, such as amorphous polyamides, are also suitable for use.

Ethylene vinyl alcohol polymers are commonly known as EVOH. Such polymers generally have an ethylene content of between about 15 mole percent to about 60 mole percent, more preferably between about 27 to about 44 mole percent. EVOH generally has a density ranging from between about 1.12 g/cm³ to about 1.20 gm/cm³ and a melting temperature ranging from between about 142° C. and 191° C. EVOH polymers can be prepared by known preparative techniques or can be obtained from commercial sources. They are prepared by saponifying or hydrolyzing ethylene vinyl acetate copolymers. The degree of hydrolysis is preferably from about 50 to 100 mole percent, more preferably from about 85 to 100 mole percent. In addition, the weight average molecular weight, M_{w}, of the EVOH component useful in the laminates of the invention, calculated from the degree of polymerization and the molecular weight of the repeating unit, may be within the range of about 5,000 M_{w}, to about 300,000 M_{w}, with about 60,000 M_{w} being most preferred. Suitable EVOH polymers for use as components in the laminated shrink films of the present invention may be obtained from EVAL Company of America under the tradename EVAL® resins. EVOH is also available under the tradename EVAL® from Kuraray Ltd. and under the tradename Soarnole from Noltex L.L.C.

The polymer compositions of the first layer can additionally comprise conventional additives used in polymeric materials including plasticizers, impact modifiers, stabilizers including viscosity stabilizers and hydrolytic stabilizers, antioxidants, ultraviolet ray absorbers, antistatic agents, dyes, pigments or other coloring agents, inorganic fillers, fire-retardants, lubricants, reinforcing agents such as glass fiber and flakes, foaming or blowing agents, processing aids, antiblock agents, release agents, and mixtures thereof. Optional additives, when used, can be present in various quantities so long as they are not used in an amount that detracts from the basic and novel characteristics of the composition or its ability to shrink to 85% or less of its original area when exposed to a temperature of 95° C.

The first layer of the laminated shrink films of the invention is a barrier layer. The term “barrier layer” as used herein denotes a film layer which allows transmission through the film of less than 1000 cc of gas, such as oxygen, per square meter of film per 24 hour period at 1 atmosphere and at a temperature of 73° F. (at 0% relative humidity). Other polymers may be present as additional components in the barrier layer so long as they do not raise the permeability of the barrier layer above the limit defined above.

The second layer of the multilayer shrink film of the invention is an adhesive composition wherein the adhesive consists essentially of 1) at least one functionalized polymer component selected from the group consisting of a) anhydride-modified polymers and mixtures thereof and b) copolymers comprising copolymerized units of ethylene and a comonomer selected from the group consisting of C₄-C₈ unsaturated anhydrides, monoesters of C₄-C₈ unsaturated acids having at least two carboxylic acid groups, diesters of C₄-C₈ unsaturated acids having at least two carboxylic acid groups and mixtures thereof, 2) an ethylene copolymer component, chemically distinct from said functionalized polymer component and 3) a tackifier.

The anhydride-modified polymers that are suitable for use as functionalized polymer components of the adhesive composition are anhydride-grafted polymers and include polymers that have been grafted with from 0.1 to 10 weight % of an unsaturated dicarboxylic acid anhydride, preferably 0.5-3.0 weight %. The polymers that are grafted may be homopolymers or copolymers. Generally, they will be grafted olefin polymers. Examples include grafted polyethylene, grafted polypropylene, grafted ethylene/vinyl acetate copolymers, grafted ethylene/alkyl acrylate copolymers and grafted ethylene/alkyl methacrylate copolymers. Specific examples include Ziegler-Natta polyethylenes of density 0.88-0.960 g/cc; polyethylenes prepared in the presence of metallocene, constrained geometry catalyzed or single-site catalysts, the polyethylenes having densities of 0.88 to 0.960 g/cc; ethylene vinyl acetate, ethylene alkyl acrylate and ethylene alkyl methacrylate copolymers wherein the vinyl acetate, alkyl acrylate or alkyl methacrylate comonomer comprises 5 to 30 wt. % of the copolymer; and random ethylene propylene copolymers having 2-10 wt. % copolymerized ethylene comonomer units. Anhydride-grafted ethylene vinyl acetate copolymers, anhydride-grafted ethylene alkyl acrylate copolymers and anhydride-grafted ethylene alkyl methacrylate copolymers are preferred. Grafting agents include unsaturated dicarboxylic acid anhydrides such as maleic anhydride, citraconic anhydride, itaconic anhydride and tetrahydrophthalic anhydride, with maleic anhydride being preferred. The anhydride group provides a reactive functionality that promotes adhesion of the composition to the other layers in the multilayer structure.

The anhydride-grafted polymers can be obtained by known techniques. For example, an ethylene copolymer such as an ethylene/vinyl acetate copolymer or an ethylene/alkyl acrylate copolymer may be dissolved in an organic solvent along with an unsaturated dicarboxylic acid anhydride, such as maleic anhydride, and a radical generator, followed by heating with stirring. Alternatively, the grafted polymers may be prepared by a process in which the reactive components are fed to an extruder, for example to provide a maleic anhydride-grafted ethylene copolymer.

When such processes are used to prepare the grafted ethylene vinyl acetate copolymers suitable for use as anhydride-grafted polymer components of the adhesive composition the relative amount of the vinyl acetate comonomer incorporated into such copolymers is generally from about 7 weight percent to as high as 45 weight percent of the total copolymer or even higher, prior to the grafting process. When an ungrafted ethylene vinyl acetate copolymer is used as the second component of the adhesive composition of the second layer, it may be preferable to use an anhydride-modified ethylene vinyl acetate copolymer as the first component. It may be further desirable to prepare the anhydride-modified polymer by using an ethylene vinyl acetate copolymer that has properties similar to those of the ethylene vinyl acetate copolymer that is the ungrafted component. Ethylene vinyl acetate copolymers having from about 20 to about 40 weight %, especially from 25 to 28% by weight, of vinyl acetate that are modified with maleic anhydride in an amount of greater than 1 weight % are useful in certain embodiments.

Grafted ethylene alkyl acrylate copolymers and ethylene alkyl methacrylate copolymers suitable for use as the anhydride-grafted polymer component of the adhesive may be prepared by grafting processes similar to those described above for other grafted polymers. When an ungrafted ethylene/alkyl acrylate copolymer or ethylene alkyl methacrylate copolymer is used as second component of the adhesive, it will sometimes be preferable to use an anhydride-modified ethylene/alkyl acrylate copolymer as the anhydride-modified component of the adhesive. It may be further desirable to use an anhydride-grafted ethylene/alkyl acrylate or ethylene alkyl methacrylate copolymer where the base resin that is grafted has properties similar to those of the ungrafted ethylene alkyl acrylate or ethylene alkyl methacrylate copolymer. Ethylene methyl acrylate copolymers having from about 20 to about 40 weight %, especially from 20 to 25% by weight, of methyl acrylate where the polymer is modified with greater than 1 weight % maleic anhydride are preferred in certain embodiments.

The alkyl groups of the alkyl acrylate or alkyl methacrylate comonomers may contain from 1 to 10 carbon atoms. Alkyl groups of 1 to 4 carbon atoms are preferred due to the ready availability of such ethylene alkyl acrylate and ethylene alkyl methacrylate copolymers. Specific examples of useful ethylene alkyl acrylate and ethylene alkyl methacrylate copolymers include ethylene methyl acrylate copolymers, ethylene ethyl acrylate copolymers, ethylene n-butyl acrylate copolymers, ethylene methyl methacrylate copolymers, ethylene ethyl methacrylate copolymers, and ethylene n-butyl methacrylate copolymers. A mixture of two or more different ethylene/alkyl acrylate or ethylene/alkyl methacrylate copolymers can be used in the adhesive composition in place of a single copolymer. Particularly useful properties may be obtained when two or more properly selected ethylene/alkyl (meth)acrylate copolymers are used.

The functionalized polymer component of the adhesive composition may also be an ethylene copolymer. The functionalized ethylene copolymer comprises copolymerized units of ethylene and a comonomer selected from the group consisting of C₄-C₈ unsaturated anhydrides, monoesters of C₄-C₈ unsaturated acids having at least two carboxylic acid groups, diesters of C₄-C₈ unsaturated acids having at least two carboxylic acid groups and mixtures of such copolymers. The ethylene copolymer will generally comprise from about 3 wt. % to about 25 wt. % copolymerized units of the comonomer. The copolymer may be a dipolymer or a higher order copolymer, such as a terpolymer or tetrapolymer. The copolymers are preferably random copolymers. Examples of suitable comonomers of the ethylene copolymer include unsaturated anhydrides such as maleic anhydride and itaconic anhydride; C₁-C₂₀ alkyl monoesters of butenedioic acids (e.g. maleic acid, fumaric acid, itaconic acid and citraconic acid), including methyl hydrogen maleate, ethyl hydrogen maleate, propyl hydrogen fumarate, and 2-ethylhexyl hydrogen fumarate; C₁-C₂₀ alkyl diesters of butenedioic acids such as dimethylmaleate, diethylmaleate, and dibutylcitraconate, dioctylmaleate, and di-2-ethylhexylfumarate. Of these, maleic anhydride, ethyl hydrogen maleate and methyl hydrogen maleate are preferred. Maleic anhydride and ethyl hydrogen maleate are most preferred.

Higher order copolymers that are examples of the ethylene copolymer component include terpolymers such as ethylene/methyl acrylate/ethyl hydrogen maleate, ethylene/butyl acrylate/ethyl hydrogen maleate and ethylene/octyl acrylate/ethyl hydrogen maleate.

The ethylene copolymers are generally prepared by high pressure free radical copolymerization processes. For example, a process for preparing ethylene/monoalkyl maleate copolymers is disclosed in U.S. Pat. No. 4,351,931.

Mixtures of more than one functionalized polymer component may also be used if desired in place of a single functionalized polymer.

The second component of the adhesive composition is an ethylene copolymer chemically distinct from the first functionalized polymer component. By chemically distinct is meant that a) the ethylene copolymer of the second component of the adhesive comprises at least one species of copolymerized monomer that is not present as a comonomer in the functionalized polymer component or b) the functionalized polymer component of the adhesive comprises at least one species of copolymerized monomer that is not present in the ethylene copolymer of the second component of the adhesive or c) the ethylene copolymer that is the second component of the adhesive is not an anhydride-grafted ethylene copolymer. Thus, the first and second polymers are different in chemical structure and are distinct polymer species.

The ethylene copolymer has copolymerized units of ethylene and a comonomer selected from the group consisting of vinyl acetate, alkyl acrylates, alkyl methacrylates and mixtures thereof. The alkyl groups will have from 1 to 10 carbon atoms. Preferred comonomers will have 1 to 4 carbon atoms. Additional comonomers may be incorporated as copolymerized units in the ethylene copolymer. Thus, the ethylene copolymer may be a terpolymer or a higher order copolymer. For example, suitable copolymerizable monomers include carbon monoxide, methacrylic acid and acrylic acid.

When the ethylene copolymer of the second component is an ethylene vinyl acetate copolymer, the percentage of copolymerized vinyl acetate units can vary broadly from 2 percent to as much as 40 weight percent of the total weight of the copolymer or even higher.

The weight percentage of copolymerized vinyl acetate units in the copolymer will preferably be from 2 to 40 weight %, especially from 10 to 40 weight %. The ethylene/vinyl acetate copolymer preferably has a melt flow rate, measured in accordance with ASTM D-1238 at 190° C., 2.16 kg wt. of from about 0.1 to about 40 g/10 minutes and especially from about 0.3 to about 30 g/10 minutes. In certain embodiments use of polymers having melt indexes from 1 to 30 g/10 minutes or 1 to 15 g/10 minutes will be preferred. The ethylene vinyl acetate copolymers will preferably have a melting range below 90° C., alternatively below 80° C.

A mixture of two or more different ethylene/vinyl acetate copolymers can be used as components of the adhesive composition in place of a single copolymer.

The ethylene copolymer of the second component may also be an ethylene alkyl acrylate or ethylene alkyl methacrylate copolymer, referred to herein as alkyl (meth)acrylate copolymers. Alkyl (meth)acrylates suitable for use as comonomers in the practice of the present invention are selected from alkyl (meth)acrylates having alkyl groups of 1 to 10 carbon atoms. Examples of alkyl acrylates suitable for use herein include, without limitation, methyl acrylate, ethyl acrylate and butyl acrylate.

The relative amount of the alkyl (meth)acrylate comonomer incorporated as copolymerized units into an ethylene alkyl (meth)acrylate copolymer useful as a component in the adhesive layer of the laminates of the present invention can vary broadly from a few weight percent to as much as 45 weight percent, based on the weight of the copolymer or even higher. Similarly, the alkyl group can be a methyl group or any alkyl group having up to ten carbon atoms. Most preferably, the alkyl group of the alkyl (meth)acrylate comonomer is methyl, ethyl or n-butyl. Preferably, the level of copolymerized units of alkyl (meth)acrylate comonomer in the ethylene alkyl (meth)acrylate copolymer is within the range of from 5 to 45 weight percent, more preferably from 10 to 35 weight %, still more preferably from 10 to 28 weight %, based on the weight of the copolymer. Mixtures of ethylene alkyl (meth)acrylate copolymers may also be used.

Ethylene copolymers suitable for use herein as the second component of the adhesive composition can be produced by any process, including processes that involve use of a tubular reactor or an autoclave. Copolymerization processes conducted in an autoclave may be continuous or batch processes. In one such process, disclosed in general in U.S. Pat. No. 5,028,674, ethylene, an alkyl acrylate, and optionally a solvent such as methanol are fed continuously into a stirred autoclave such as the type disclosed in U.S. Pat. No. 2,897,183, together with an initiator. Ethylene alkyl acrylate copolymers produced using an autoclave process can be obtained commercially, for example from Exxon/Mobil Corp, and/or from Elf AtoChem North America, Inc. Ethylene alkyl (meth)acrylate copolymers obtained using a tubular reactor process are produced at high pressure and elevated temperature. In a tubular reactor, the inherent consequences of dissimilar reaction kinetics for the respective ethylene and alkyl acrylate comonomers are alleviated or partially compensated for by the intentional introduction of monomers along the reaction flow path within the tubular reactor. Such copolymers can be obtained commercially from E. I. du Pont de Nemours and Company.

The molecular weight and melt index of ethylene alkyl (meth)acrylate copolymers suitable for use as the second component of the adhesive composition can vary significantly. The specific melt index that is desirable may depend on the balance of properties sought from the blend, for example to provide a desired mix of oxygen barrier and structural properties needed for a specific packaging structure.

For the purposes of the present invention, it is contemplated that the ethylene copolymer that is the second component of the adhesive can be a mixture of components, including mixtures of various species of a particular copolymer, so long as the shrink properties of the adhesive are not compromised. For example, ethylene alkyl (meth)acrylates having various melt indices, or having different alkyl groups, can be utilized.

Examples of higher order ethylene copolymers useful as the second component of the adhesive composition include ethylene alkyl(meth)acrylate carbon monoxide terpolymers. Preferred examples are those wherein the alkyl group of the (meth)acrylate comonomer contains from one to four carbon atoms. The relative amount of the alkyl (meth)acrylate comonomer incorporated into the ethylene (meth)alkyl acrylate carbon monoxide terpolymer can vary broadly from a few weight percent up to as high as 40 weight percent of the total weight of the copolymer or even higher. Similarly, the choice of the alkyl group can vary. The alkyl group may be straight chain or branched. Preferably, the alkyl group will contain from one to four carbon atoms and the alkyl (meth)acrylate comonomer will comprise from 6 to 40 weight percent of the total weight of the ethylene alkyl (meth)acrylate copolymer, preferably from 12 to 32 weight %. Ethylene alkyl acrylate carbon monoxide terpolymers are preferred. Of note are ethylene n-butyl acrylate carbon monoxide terpolymers.

These terpolymers can be prepared by copolymerization of ethylene, alkyl (meth)acrylate and carbon monoxide by either autoclave or tubular processes, similar to those processes described above. Suitable ethylene alkyl (meth)acrylate CO copolymers include Elvaloy® HP resins available from DuPont

The third component of the adhesive composition is a tackifier. The presence of the tackifier enhances initial adhesion to differentiated substrates. The tackifier improves wetting during application of the adhesive. The presence of tackifier lowers resistance to deformation of the adhesive composition and hence facilitates bond formation on contact. It also facilitates bond adhesion when the film is oriented and later shrunk.

The tackifier may be any suitable tackifier known generally in the art. For example, the tackifier may include, but is not limited to types listed in U.S. Pat. No. 3,484,405. Suitable tackifiers include a variety of natural and synthetic resins and rosin materials. Tackifier resins that can be employed are liquid, semi-solid to solid, complex amorphous materials generally in the form of mixtures of organic compounds having no definite melting point and no tendency to crystallize. Such resins are insoluble in water and can be of vegetable or animal origin, or can be synthetic resins. Suitable tackifiers include but are not necessarily limited to the resins discussed below.

One class of tackifier suitable for use in the adhesive compositions of the invention includes coumarone-indene resins, such as the para-coumarone-indene resins. Generally the coumarone-indene resins that can be employed have a molecular weight that ranges from about 500 to about 5,000. Other suitable tackifiers are terpene resins, including styrenated terpenes. These terpene resins can have molecular weights ranging from about 600 to 6,000.

Other tackifiers suitable for use in the adhesive composition are butadiene-styrene resins having molecular weights ranging from about 500 to about 5,000. Polybutadiene resins having molecular weights ranging from about 500 to about 5,000 are also useful as tackifiers. Buton® resins are examples of such tackifiers.

Another class of resins that can be employed as the tackifier component includes hydrocarbon resins produced by catalytic polymerization of selected fractions obtained in the refining of petroleum, and having a molecular weight range of about 500 to about 5,000. Examples of such resins are those marketed as Piccopale® 100 resins. Similarly, polybutenes obtained from the polymerization of isobutylene may be included as tackifiers. Hydrogenated hydrocarbon resins such as Regalite® resins available from Eastman Chemical Company are also suitable.

The tackifier may also be a rosin material, a low molecular weight styrene hard resin or a disproportionated pentaerythritol ester.

Rosins useful as tackifiers may be any standard material of commerce known as “rosin”, or a feedstock containing rosin. Rosin is mainly a mixture of C₂₀, tricyclic fused-ring, monocarboxylic acids, typified by pimaric and abietic acids, which are commonly referred to as “resin acids.” In the context of this invention, the term “rosin” collectively includes natural rosins, liquid rosins, modified rosins and the purified rosin acids, and derivatives of rosin acids, including partially to completely neutralized salts with metal ions, e.g. resinate, etc. The rosin material may be modified rosin such as dimerized rosin, hydrogenated rosin, disproportionated rosin, or esters of rosin. Essentially any reaction conditions recognized in the art for preparing modified rosin resins (including derivatives thereof) may be employed to prepare a modified rosin for use in the present invention. Reaction products of rosins and their methods of preparation are well known in the art (See for example U.S. Pat. No. 2,007,983).

Aromatic tackifiers include thermoplastic hydrocarbon resins derived from styrene, alpha-methylstyrene, and/or vinyltoluene, and polymers, copolymers and terpolymers thereof, terpenes, terpene phenolics, modified terpenes, and combinations thereof. These may be further hydrogenated in part or in entirety to produce alicyclic tackifiers.

A more comprehensive listing of tackifiers that can be employed in this invention is provided in the TAPPI CA Report#55, February 1975, pages 13-20, inclusive, a publication of the Technical Association of the Pulp and Paper Industry, Atlanta, Ga., which lists over 200 commercially available tackifier resins.

The components of the adhesive composition will generally be present in certain preferred ratios. That is, in general the amount of the first functionalized polymer component will be present in an amount of 5-30 wt. %, based on the total weight of the adhesive composition. Preferably, the amount of functionalized polymer component will be 8-25 wt. % of the adhesive composition because such compositions generally are less colored than those having higher amounts of functionalized polymer. The ethylene copolymer that is the second component of the adhesive will generally be present in the adhesive composition in an amount of from 60-90 wt. % based on the total weight of the adhesive, preferably 65-85 wt. %, based on the total weight of the adhesive composition. The tackifier will usually be present in an amount of from 0.1-20 wt. %, based on the weight of the adhesive composition, preferably from 5-15 wt. %. A particularly useful composition includes 20-25 wt. % functionalized polymer component, 5-15 wt. % ethylene copolymer component and 5-15 wt. % tackifier, based on the total weight of the adhesive composition.

The adhesive compositions may additionally include various commonly used additives and fillers such as described above for use in the first layer of the laminate. Some particularly useful additives may include antioxidants, antistatic additives and antifog additives.

The adhesive composition may also include additional polymeric materials so long as the basic and novel characteristics of the adhesive composition are not materially affected, including the ability of the laminate that comprises the composition to shrink to 85% or less of its original area when exposed to a temperature of 95° C. Examples of such polymers include ethylene propylene diene elastomers, i.e. EPDMs, ethylene propylene elastomers and ethylene styrene elastomers. These polymers may be included in amounts up to about 20 wt. %, preferably from about 5 to about 15 wt. %, based on the total weight of the adhesive composition.

The third layer of the multilayer laminated heat shrinkable films of the invention comprises a polymer selected from the group consisting of polyethylene homopolymers, ethylene copolymers, polypropylene homopolymers, propylene copolymers, polyesters, polyamides, polyvinyl chloride, polycarbonates, and mixtures thereof.

Suitable polyethylenes include branched polyethylenes, such as low density polyethylenes, linear low density polyethylenes, ultra low density polyethylenes, very low density polyethylenes, metallocene polyethylenes, ethylene propylene copolymers and copolymers of ethylene, propylene and a diene monomer. These latter copolymers are commonly referred to in the art as EPDM copolymers. EPDMs include terpolymers as well as higher order copolymers such as tetrapolymers. Tetrapolymers include, for example, copolymers of ethylene, propylene, 1,4-hexadiene and ethylidene norbornene. The term metallocene polyethylenes is meant to include those polyethylenes that are prepared in the presence of metallocene catalysts as well those prepared in the presence of constrained geometry catalysts and single site catalysts.

Polyethylene homopolymers and copolymers useful as components of the third layer of the laminate compositions described herein can be prepared by a variety of methods. Examples of such processes include, but are not limited to, the well-known Ziegler-Natta catalyst polymerization (see for example U.S. Pat. Nos. 4,076,698 and 3,645,992), metallocene catalyzed polymerization, Versipol™ single-site catalyst polymerization and free radical polymerization. As used herein, the term metallocene catalyzed polymerization includes polymerization processes that involve the use of metallocene catalysts as well as those processes that involve use of constrained geometry and single-site catalysts. Polymerization can be conducted as a solution phase process, a gas phase process, and the like.

The densities of polyethylenes suitable for use range from about 0.850 g/cc to about 0.970 g/cc, preferably from about 0.850 g/cc to about 0.930 g/cc, more preferably from about 0.850 g/cc to about 0.910 g/cc. Linear polyethylenes useful in the compositions of the invention can incorporate copolymerized units of alpha-olefin comonomers such as butene, hexene or octene to provide preferred copolymers within the density ranges so described. For example, a copolymer useful as the polyolefin component can comprise a major portion or percentage by weight of copolymerized units of ethylene and a minor portion or percentage by weight of copolymerized units of at least one other alpha-olefin. Suitable alpha-olefins can be selected from the group consisting of alpha-olefins having at least three carbon atoms, preferably from 3 to 20 carbon atoms. These comonomers are present as copolymerized units in an amount of up to about 20 weight % of the copolymer. Preferred alpha-olefins include propylene, 1-butene, 1-hexene, 4-methyl-1 -pentene, 1 -octene, 1 -decene, 1 -tetradecene and 1 -octadecene. Copolymers can be obtained by polymerization of ethylene with two or more alpha-olefins, preferably including propylene, 1-butene, 1-octene and 4-methyl-1-pentene. Also contemplated for use herein as a polyolefin are blends of two or more of these ethylene alpha-olefin copolymers as well as mixtures of an ethylene homopolymer and one of the suitable ethylene alpha-olefin copolymers. Ethylene copolymers having small amounts of a diolefin component such as butadiene, norbornadiene, hexadiene and isoprene are also generally suitable for preparation of blended compositions.

Thus, when the polyolefin is a copolymer it may be an ethylene/propylene elastomer that has double bonds. Such copolymers include EPDMs that are terpolymers, tetrapolymers or higher order copolymers formed by copolymerization of ethylene, propylene, dienes and optionally other olefin comonomers.

Block copolymers are made up of chain segments consisting of propylene homopolymer and of chain segments consisting of, for example, random copolymers of propylene and ethylene.

Other suitable ethylene copolymers that comprise the third layer include ethylene/acid copolymer ionomers, ethylene vinyl acetate copolymers, ethylene alkyl acrylate copolymers and ethylene alkyl methacrylate copolymers. Suitable ethylene vinyl acetate copolymers, ethylene alkyl acrylate copolymers and ethylene alkyl methacrylate copolymers are those that are also suitable for use as the second component of the adhesive composition and which have been described above.

Ethylene acid copolymers may be prepared by copolymerization of ethylene and an unsaturated carboxylic acid, such as for example acrylic acid or methacrylic acid. Ethylene acid copolymers also include higher order copolymers such as terpolymers. Terpolymers can be prepared from ethylene, an unsaturated carboxylic acid and a third comonomer such as an alkyl acrylate or alkyl methacrylate. Accordingly, an acid copolymer useful for the third layer of the laminated film of the invention comprises copolymerized units of ethylene, a C₃ to C₈ α,β ethylenically unsaturated carboxylic acid, preferably acrylic acid or methacrylic acid and, optionally copolymerized units derived from additional comonomers, preferably alkyl acrylate or alkyl methacrylates wherein the alkyl groups have from one to ten, preferably one to four, carbon atoms. Some particularly useful terpolymers are those wherein the unsaturated acid content is about 2-30 weight % copolymer and additional comonomers are present in an amount of up to about 40 weight % of the copolymer (i.e. terpolymer or higher order copolymer).

Ionomers are acid copolymers wherein at least some of the carboxylic acid moieties in the copolymer are neutralized to form the corresponding carboxylate salts. lonomers can be prepared from the acid copolymers described above, wherein the carboxylic acid functionalities present as a result of copolymerization of the unsaturated acid are at least partially neutralized by alkali metal ions, transition metal ions, alkaline earth ions or combinations of such cations.

Compounds suitable for neutralizing the acid copolymer include ionic compounds of alkali metal (for example, lithium, sodium or potassium) ions, transition metal ions (for example, zinc) or alkaline earth ions (for example magnesium or calcium) and mixtures or combinations of such cations. Ionic compounds that may be used for neutralizing the ethylene acid copolymers include formates, acetates, nitrates, carbonates, hydrogen carbonates, oxides, hydroxides or alkoxides of the alkali metals, and formates, acetates, nitrates, oxides, hydroxides or alkoxides of alkaline earth metals and transition metals. The amount of compound capable of neutralizing acidic groups may be provided by adding the stoichiometric amount of the compound calculated to neutralize a target amount of acid moieties in the acid copolymer.

Suitable ethylene acid copolymers and ionomers that are commercially available include Nucrel® acid copolymers and Surlyn® ionomer resins, both available from E. I. du Pont de Nemours and Company.

Polypropylene polymers suitable for use as components of the third layer of the laminates of the invention include homopolymers, random copolymers, block copolymers and terpolymers of propylene. Copolymers of propylene include copolymers of propylene with other olefins such as 1-butene, 2-butene and the various pentene isomers, etc. and preferably copolymers of propylene with ethylene. Copolymers of propylene and ethylene have been described above. Random copolymers, also known as statistical copolymers, are polymers in which the propylene and the comonomer(s) are randomly distributed throughout the polymeric chain in ratios corresponding to the feed ratio of the propylene to the comonomer(s). These polymers are also suitable for use in the third layer of the laminates of the invention.

Polypropylene homopolymers or random copolymers suitable for use in the present invention can be manufactured by any known process. For example, polypropylene polymers can be prepared in the presence of Ziegler-Natta catalyst systems, based on organometallic compounds and on solids containing titanium trichloride.

Block copolymers can be manufactured similarly, except that propylene is generally first polymerized by itself in a first stage and propylene and additional comonomers such as ethylene are then polymerized, in a second stage, in the presence of the polymer obtained during the first. Each of these stages can be carried out, for example, in suspension in a hydrocarbon diluent, in suspension in liquid propylene, or else in gaseous phase, continuously or noncontinuously, in the same reactor or in separate reactors.

Polyamides, such as those described for use in the first layer of the laminate of the invention are also suitable for use in the third layer. In addition, polycarbonates, polyvinyl alcohols, polyesters and cyclic olefin copolymers may be utilized as components of the third layer, alone or in combination with another polymer.

Polyesters useful in the third layer include polymers derived from condensation of diols and diacids (or derivatives thereof) that are suitable for forming films. Of note are polyesters comprising aromatic dicarboxylic acids as the main acid component. Examples include polyethylene terephthalate, polytetramethylene terephthalate, polycyclohexane-dimethylene terephthalate and polyethylene-2,6-naphthalene dicarboxylate. These polyesters may also be copolymers copolymerized with either another alcohol and/or another dicarboxylic acid as additional components. A portion of the dicarboxylic acid moiety thereof may be substituted by isophthalic acid, 2,6-naphthalene-dicarboxylic acid, 1,4-cyclohexanedicarboxylic acid, adipic acid, sebacic acid, dimer acid, and isophthalic acid containing a metal salt of sulfonic acid as a substituent, such as 5-sodium sulfoisophthalate, for example. Part of the glycol moiety thereof may be substituted by diethylene glycol, neopentyl glycol, 1,4-cyclohexane diol, 1,4-cyclohexanedimethanol, polyalkylene glycol, 1,2 propanediol, 1,3 propanediol (trimethylene glycol) and 1,4 butanediol, for example. Use of a small amount of a chain-branching agent such as pentaerythritol, trimethylol propane, trimellitic acid, trimesic acid, or boric acid is also contemplated. Mixtures of two or more of these polyesters also may be used. The term polyester when used herein is used generically to refer to any or all of the polymers described above. The polyester blends preferably have polyethylene terephthalate, polypropylene terephthalate or polybutylene terephthalate as main components thereof, and a particularly preferred polyester is polyethylene terephthalate.

Cyclic olefin copolymers can be prepared by copolymerization of ethylene and a cyclic olefin, typically derived from dicyclopentadiene, such as 2-norbornene. are copolymers of ethylene and 2-norbornene. These copolymers have excellent transparency and moisture vapor barrier properties. Commercially available examples include Topas® resins, available from Topas Advanced Polymers GmbH.

In some instances blends of polymers may be useful as components of the third layer. S with the first layer, the third layer can additionally comprise conventional additives as describe herein, used in quantities that do not detract from the ability of the laminated film to shrink to 85% or less of its original area when exposed to a temperature of 95° C.

The laminated films of the present invention comprise the above described first layer, adhesive layer and third layer, wherein the adhesive layer is in contact with and disposed between the firsthand third layer. The laminated films of the invention may also include additional layers. For example, an additional layer may be so disposed that it contacts the outer surface of either of the first or third layers. Additional layers may be disposed so that they contact the outer surfaces of both the first or third layers. Further, a series of laminated layers may be disposed on either or both of the first and third layers to form a multilayer laminated film or structure. In any such laminate of the invention a three layer laminate of the above described first layer, adhesive layer and third layer will be present in the laminated structure, and the adhesive will be disposed between those layers and in contact with their inner surfaces. Multilayer shrink films often will have three to nine layers comprising one or two adhesive, or “tie”, layers respectively.

Representative examples of laminates of the invention include the multilayer structures described below, where the adhesive of the second layer of the laminated shrink films of the invention is designated as “adhesive.” In the multilayer film structures described the symbol “/” represents a boundary between layers. The laminates below are not meant to be exhaustive list of the laminates of the invention and are for purposes of example.
Polyamide/adhesive/polyethylene homopolymer
Polyamide/adhesive/polypropylene
Polyamide/adhesive/polyamide;
Ethylene vinyl alcohol/adhesive/polyethylene,
Ethylene vinyl alcohol/adhesive/ethylene vinyl acetate;
Polyamide/adhesive/ethylene alkyl acrylate copolymer
Polyamide/adhesive/ethylene (meth)acrylic acid copolymer;
Ethylene vinyl alcohol/adhesive/ethylene acrylic acid copolymer ionomer
Ethylene vinyl alcohol/adhesive/polyester;
Polyamide/adhesive/polyethylene/adhesive/polyamide,
Polyethylene/adhesive/polyamide/adhesive/polyethylene,
Polyester/adhesive/polyamide/adhesive/polyester;
Ethylene vinyl acetate/adhesive/EVOH/adhesive/ethylene (meth)acrylic acid ionomer
Polyethylene/adhesive/EVOH/adhesive/ethylene (meth)acrylic acid ionomer
Polyamide/adhesive/polyethylene/adhesive/polyethylene,
Polyethylene/adhesive/polyamide/ethylene vinyl
alcohol/polyamide/adhesive/polyethylene,
Polyethylene/adhesive/polyamide/EVOH/polyamide/adhesive/ethylene vinyl acetate,
Ethylene vinyl acetate/adhesive/polyamide/EVOH/polyamide/adhesive/polyethylene,
Ethylene methyl acrylate copolymer/adhesive/polyamide/EVOH/polyamide/adhesive/EVA,
Polypropylene/adhesive/polyamide/EVOH/polyamide/adhesive/polyrpropylene,
Polypropylene/adhesive/polyamide/EVOH/polyamide/adhesive/polyethylene,
Polypropylene/adhesive/polyamide/EVOH/polyamide/adhesive/EVA, and
Polyester/adhesive/polyamide/EVOH/polyamide/adhesive/polyester.

Those skilled in the art will recognize that other film laminate structures will fall within the scope of the invention. Such structures include multilayer shrink film laminates that contain one or more adhesive layers in addition to the second layer of the claimed laminate of the present invention and wherein the adhesive in such additional tie layer(s) does not meet the above description of the composition of the second layer. Each embodiment will have particular advantages depending on the packaging application.

The adhesive layer that forms the second layer of the laminated heat shrinkable films of the invention provides a level of interlayer adhesion, as demonstrated by peel strength, of at least about 85 gm/25 mm without using an annealing step or further heat treatment on the film. Peel strengths of at least about 100 gm/25 mm are preferable and those of at least about 150 gm/25 mm are more preferable. In a preferred embodiment, the laminated shrinkable films have peel strengths of at least about 200 gm/25 mm. More preferred films exhibit peel strengths of greater than about 300 gm/25 mm. Other preferred embodiments include films where the peel strength greater than about 400 gm/25 mm is obtained without exposing the film to an annealing step or heat treatment step after biaxial orientation. Most preferably, a shrink film has peel strength of greater than about 500 gm/25 mm. Depending on the use or application of the shrink film, more or less adhesion within the delineated ranges can be appropriate or even desirable. One of ordinary skill in the art will select the level of adhesion that is most appropriate for the film, considering such factors as the level of performance required in the final film, the cost of materials, and the likelihood of failure at the adhesive interface, for example.

The multilayer laminated heat shrinkable films of the invention are oriented to provide shrinkability. The temperature selected for orienting a film can depend on many factors, including the type and identity of the film layers being oriented, the melt index of the components of the film, the stretching forces applied to the film during the orientation process, the speed of the film production line, and/or the degree of stretching desired. The present invention is not limited by any example; however many conventional orientation processes can be conducted within a range of from about 70° C. to about 125° C. Any individual temperature within this range can be useful in orienting a film for use in shrink applications, depending on at least some of the factors listed herein. Many conventional orientation processes are carried out within a temperature range of from about 85° C. to about 100° C.

The laminate can be manufactured by laminating individual layers, preferably by extrusion coating, coextrusion or blow molding. Although the thickness of the laminate is arbitrary and dependent on its application, it is preferably from about 10 to about 3000 82 m, and in particular, from about 20 to about 1000 μm, for example. The laminate may optionally be irradiated by processes known in the art.

A laminated film can be prepared by coextrusion as follows: granulates of the various components are melted in suitable extruders and converted into a film using a converting technique. For coextrusion, the molten polymers are passed through a die or set of dies to form layers of molten polymers that are processed as a layered flow and then cooled to form a layered structure. The film may also be prepared by coextrusion followed by lamination onto one or more other layers. Suitable converting techniques include blown film extrusion, cast film extrusion, cast sheet extrusion and extrusion coating. A preferred film is a blown film obtained through blown film extrusion.

The film is further oriented beyond the immediate quenching or casting of the film. In general terms the process comprises the steps of coextruding a multilayer flow of molten polymers, quenching the coextrudate and orienting the quenched coextrudate in at least one direction. The film may be uniaxially oriented, but is preferably biaxially oriented by drawing in two mutually perpendicular directions in the plane of the film to achieve a satisfactory combination of mechanical and physical properties.

Orientation and stretching apparatus to uniaxially or biaxially stretch film are known in the art and may be adapted by those skilled in the art to produce the films. Examples of such apparatus and processes are believed to include e.g. those disclosed in U.S. Pat. Nos. 3,278,663; 3,337,665; 3,456,044; 4,590,106; 4,760,116; 4,769,421; 4,797,235 and 4,886,634.

In a preferred embodiment, the film is oriented through a double bubble extrusion process, where simultaneous biaxial orientation may be effected by extruding a primary tube which is subsequently quenched, reheated and then expanded by internal gas pressure to induce transverse orientation, and drawn by differential speed nip or conveying rollers at a rate which will induce longitudinal orientation. More particularly, a primary tube is melt extruded from an annular die. This extruded primary tube is cooled quickly to minimize crystallization and then collapsed. It is then again heated to its orientation temperature (e.g. by means of a water bath). In the orientation zone a secondary tube is formed by inflation, thereby radially expanding the film in the transverse direction, and the tube is pulled or stretched in the machine direction at a temperature such that expansion occurs in both directions, preferably simultaneously; the expansion of the tubing being accompanied by a sharp, sudden reduction of thickness at the draw point. The tubular film can then again be flattened through nip rolls. Flat films can be prepared by splitting the tubular film along its length and opened up into flat sheets that can be rolled and/or further processed.

Preferably, the film can be processed on the manufacturing machine at a speed higher than 50 meters per minute (m/min), and up to a speed of 200 m/min. The film is therefore compatible with high-speed machines.

The tubular film may also be processed into shrink bags by forming seals (for example, by heat-sealing or radio-frequency welding) across the tube surface and cutting the sealed tube into lengths, thereby providing tubes with one closed end and one open end. Materials to be packaged can be inserted into the tubes through the open end and then sealed to form filled shrink bags by sealing the open ends of the tubes. In some cases, the operations of forming the shrink bag, filling and sealing can be carried out consecutively and/or simultaneously using automated machinery.

The invention is further illustrated in the following Examples.

### EXAMPLES

As used in the Examples below, melt index (MI) refers to melt index as determined according to ASTM D1238 at 190° C. using a 2160 g weight, with values of MI reported in g/10 minutes.

The following materials are used:

EMA-1—ethylene methyl acrylate (“MA”) dipolymer (18 wt. % MA, MI 2, density 0.94 g/cc).

EMA-2—ethylene methyl acrylate dipolymer (20 wt. % MA, MI 8, density 0.94 g/cc).

EMA-3—ethylene methyl acrylate dipolymer (9 wt. % MA, MI 2, density 0.93 g/cc).

EMA-4—ethylene methyl acrylate dipolymer (4 wt. % MA, MI 1).

EVA-1—ethylene vinyl acetate (“VA”) dipolymer (25 wt. % VA, MI 2, density 0.95 g/cc).

EVA-2—ethylene vinyl acetate dipolymer (9 wt. % VA, MI 2, density 0.93 g/cc).

EEHM-1—ethylene ethyl hydrogen maleate dipolymer (9.5 wt. % ethyl hydrogen maleate.

EAO-1—ethylene butene dipolymer (density 0.92 g/cc, MI 1).

EAO-2—ethylene butene dipolymer (density 0.88 g/cc, MI 1).

EAO-3—ethylene butene dipolymer (density 0.92 g/cc, MI 12).

EAO4—ethylene octene dipolymer (density 0.86 g/cc, MI 13).

EAO-5—ethylene propylene dipolymer (density 0.87 g/cc, MI 0.7).

PE-1—polyethylene (density 0.923 g/cc, MI 4.5).

PE-2—polyethylene (density 0.923 g/cc, MI 15).

Graft-1—ethylene methyl acrylate dipolymer (20 wt. % MA, 1.4 wt. % grafted maleic anhydride, MI 3).

Graft-2—ethylene methyl acrylate dipolymer (24% wt. MA, 1.8 wt. % grafted maleic anhydride, MI 2).

Graft-3—ethylene vinyl acetate dipolymer (28 wt. % MA, 1.5 wt. % grafted maleic anhydride, MI 1.4).

Graft4—metallocene linear low density polyethylene (1 wt. % grafted maleic anhydride, MI 3).

Graft-5—Ziegler-Natta linear low density polyethylene (0.9 wt. % grafted maleic anhydride, MI 1.5).

Tackifier-1—Regalite® R1125 (PINOVA).

Tackifier-2—Escorez® 5320 (ExxonMobil Corporation).

Tackifier-3—Piccolyte® C115 (PINOVA).

An adhesive composition, identified in Table 1 below as “AD2”, is prepared according to the following procedure. The components of AD2 were dry blended in a tumble mixer, and the dry blend was then fed into the hopper of a 2.5 inch single-screw extruder with a mixing head, operated at 46 RPM. The extruder barrels were set at 160° C., 180° C., 188° C., 188° C.; the dies at 188° C. The compounded blend melt temperature was 195° C. and was cooled in a water quench bath and then strand cut with a pelletizer. The weight percentages of each component in the AD2 composition are shown in Table 1.

Other adhesive compositions, identified in Table 1 as AD3-AD6 and AD9-AD11 and comparative adhesive compositions, identified in Table 2 as CAD1, CAD7 and CA8, are prepared in substantially the same manner. Weight percentages of the components of the adhesive compositions and comparative adhesive compositions are shown in Tables 1 and 2.

TABLE 1

| | AD2 | AD3 | AD4 | AD5 | AD6 | AD9 | AD10 | AD11 |
|---|---|---|---|---|---|---|---|---|
| EMA-1 | 70 | | | | | 60 | | |
| EMA-2 | | | | | | | | 80 |
| EMA-3 | | | 80 | | | | | |
| EMA-4 | | | | 80 | | | | |
| EVA-1 | | 70 | | | 80 | | 70 | |
| EEHM-1 | | | | | | | 20 | 15 |
| EAO-2 | | | | | | 10 | | |
| Graft-2 | 20 | | | | | 20 | | |
| Graft-3 | | 20 | | | | | | |
| Graft-4 | | | 15 | 15 | | | | |
| Graft-5 | | | | | 15 | | | |
| Tacki- | 10 | 10 | 5 | | | 10 | 10 | |
| fier-1 | | | | | | | | |
| Tacki- | | | | 5 | | | | |
| fier-2 | | | | | | | | |
| Tacki- | | | | | 5 | | | 5 |
| fier-3 | | | | | | | | |

TABLE 2

| | CAD1 | CAD7 | CAD 8 |
|---|---|---|---|
| EMA 1 | 50 | | |
| EMA 2 | 15 | | |
| EAO 1 | | 29 | |
| EAO 2 | 20 | | 40 |
| EAO 3 | | 21 | |
| EAO 4 | | | 25 |
| EAO 5 | | 23 | |
| PE1 | | 5 | |
| PE 2 | | | 20 |
| Graft 1 | 15 | | |
| Graft 4 | | 22 | |
| Graft 5 | | | 15 |

A multilayer shrink film of the invention is prepared from the AD2 adhesive in the following manner. Three-mil thick, five-layer biaxially oriented films are made on a commercial double bubble line with the following structure and properties, where in this case adhesive tie layer 2 was formed from AD2. Adhesive tie layer 1 was a different adhesive composition.

EVA/adhesive tie layer 1/Nylon/adhesive tie layer 2/Ethylene copolymer

Layer thicknesses: 1.3 mils/0.3 mils/0.5 mils/0.3 mils/0.6 mils

Layflat is 12 inches. Shrinkage from the original dimensions of the film at 95° C. is about 42% in the transverse direction and about 33% in the longitudinal direction.

The film is cut into one-inch-wide strips, then separated at the EVA/AD2/nylon side and tested for peel strength of the AD2 layer to the nylon layer generally using the procedure of ASTM D-1876-72.

Other multilayer films of the invention and multilayer films having adhesive tie layers formed from the comparative adhesive compositions are prepared in substantially the same manner.

Five-layer, 2.5-mil thick biaxially oriented films are made on a commercial double bubble line with the following structure and properties:

Very Low Density Polyethylene/Adhesive Tie Layer 1/Nylon/Adhesive Tiel Layer 1/EVA

Layer Thickness: 1 mil/0.13 mils/0.25 mils/0.13 mils/1 mil

Layflat: 16.5 inches

Shrinkage from the original dimensions of the film when exposed to a temperature of 95° C. is about 41% in the machine direction and 44% in the transverse direction.

The films are cut into one-inch-wide strips, then separated at the EVA/Adhesive Tie Layer 1/nylon side and tested for peel strength of the Adhesive Tie Layer 1 layer to the nylon layer using the procedure of ASTM D-1876-72.

What is claimed is:

1. A multilayer laminated heat shrinkable film comprising
A) a first layer having an outer surface and an inner surface, said first layer comprising a polymer selected from the group consisting of polyamides, ethylene vinyl alcohol copolymers and mixtures thereof;
B) a second layer consisting essentially of
1) at least one functionalized polymer component selected from the group consisting of a) anhydride-modified polymers, b) copolymers comprising copolymerized units of ethylene and a comonomer selected from the group consisting of C₄-C₈ unsaturated anhydrides, monoesters of C₄-C₈ unsaturated acids having at least two carboxylic acid groups, diesters of C₄-C₈ unsaturated acids having at least two carboxylic acid groups and c) mixtures thereof,
2) an ethylene copolymer, chemically distinct from said functionalized polymer component, comprising copolymerized units of ethylene and a comonomer selected from the group consisting of vinyl acetate, alkyl acrylates, alkyl methacrylates and mixtures thereof, said alkyl groups having from 1 to 10 carbon atoms; and
3) a tackifier resin; and
C) a third layer having an outer surface and an inner surface, said third layer comprising a polymer selected from the group consisting of polyethylene homopolymers, ethylene copolymers, polypropylene homopolymers, propylene copolymers, polyesters, polyamides, polyvinyl chloride, polycarbonates, cyclic olefin polymers, and mixtures thereof
wherein said second layer is positioned between and in contact with the inner surfaces of said first and third layers and, when subjected to a temperature of 95° C., said shrinkable film will shrink to an extent such that it is 85% or less of its original size.

2. A multilayer laminated heat shrinkable film of claim 1 wherein the first layer comprises a polyamide.

3. A multilayer laminated heat shrinkable film of claim 1 wherein the first layer comprises an ethylene vinyl alcohol copolymer.

4. A multilayer laminated heat shrinkable film of claim 1 wherein the functionalized polymer of the second layer is an anhydride-modified polymer.

5. A multilayer laminated heat shrinkable film of claim 4 wherein the anhydride-modified polymer is an anhydride-modified ethylene copolymer.

6. A. multilayer laminated heat shrinkable film of claim 5 wherein the ethylene copolymer is selected from the group consisting of ethylene vinyl acetate copolymers, ethylene alkyl acrylate copolymers and ethylene alkyl methacrylate copolymers.

7. A multilayer laminated heat shrinkable film of claim 1 wherein the functionalized polymer of the second layer is a copolymer comprising copolymerized units of ethylene and a comonomer selected from the group consisting of C₄-C₈ unsaturated anhydrides, monoesters of C₄-C₈ unsaturated acids having at least two carboxylic acid groups, diesters of C₄-C₈ unsaturated acids having at least two carboxylic acid groups.

8. A multilayer laminated heat shrinkable film of claim 1 wherein the ethylene copolymer, chemically distinct from the functionalized polymer component of the second layer is a copolymer comprising copolymerized units of ethylene and vinyl acetate.

9. A multilayer laminated heat shrinkable film of claim 1 wherein the ethylene copolymer, chemically distinct from the functionalized polymer component of the second layer is a copolymer comprising copolymerized units of ethylene and an alkyl acrylate, said alkyl groups having from 1 to 10 carbon atoms.

10. A multilayer laminated heat shrinkable film of claim 1 wherein the ethylene copolymer, chemically distinct from the functionalized polymer component of the second layer is a copolymer comprising copolymerized units of ethylene and an alkyl methacrylate, said alkyl groups having from 1 to 10 carbon atoms.

11. A multilayer laminated heat shrinkable film of claim 1 wherein the third layer comprises a polyamide.

12. A multilayer laminated heat shrinkable film of claim 1 wherein the third layer comprises an ethylene copolymer.

13. A multilayer laminated heat shrinkable film of claim 1 wherein the third layer comprises a polyethylene homopolymer.

14. A multilayer laminated heat shrinkable film of claim 1 wherein the third layer comprises a polyester.

15. A multilayer laminated heat shrinkable film of claim 1 wherein the third layer comprises a propylene copolymer.

16. A multilayer laminated heat shrinkable film of claim 1 wherein the third layer comprises a polycarbonate.

17. A multilayer laminated heat shrinkable film of claim 12 wherein the ethylene copolymer is an ethylene acid copolymer.

18. A multilayer laminated heat shrinkable film of claim 12 wherein the ethylene copolymer comprises an ionomer of an ethylene acid copolymer.

19. A multilayer laminated heat shrinkable film of claim 1 wherein the film comprises additional layers.

20. A multilayer laminated heat shrinkable film of claim 19 having at least five layers.

21. A shrink bag comprising a multilayer laminated heat shrinkable film of claim 1.

22. A multilayer laminated heat shrinkable film of claim 1 that when subjected to a temperature of 95° C. will shrink to an extent such that it is 70% or less of its original size.

23. A multilayer laminated heat shrinkable film of claim 1 that when subjected to a temperature of 95° C. will shrink to an extent such that it is 50% or less of its original size.

24. A multilayer laminated heat shrinkable film of claim 1 in the form of a tube.

25. A multilayer laminated heat shrinkable film of claim 1 wherein the third layer comprises an ethylene copolymer.

26. A multilayer laminated heat shrinkable film of claim 1 wherein the third layer comprises a polypropylene homopolymer.

27. A multilayer laminated heat shrinkable film of claim 1 wherein the third layer comprises a cyclic olefin polymer.
